(19) United States
(12) Patent Application Publication
(10) Pub. No.: US 2011/0045830 A1
(43) Pub. Date: Feb. 24, 2011

(54) METHOD OF MANAGING HOME CELL SELECTION FOR A WIRELESS COMMUNICATION SYSTEM AND RELATED DEVICE

(76) Inventor: Chih-Hsiang Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/545,854

(22) Filed: Aug. 23, 2009

(51) Int. Cl. H04W 60/00

(52) U.S. Cl. 455/435.2

(57) ABSTRACT

A method of managing home cell selection for a user equipment of a wireless communication system including a whitelist capable of providing a list of accessible home cells includes utilizing a flag for storing a preference list of at least one of home cells and macro cells. The home cells are preferably a Closed Subscriber Group cell.

### BACKGROUND OF THE INVENTION

1. Field of the Invention

The present invention relates to a method and communication device utilized in a wireless communication system, and more particularly, to a method and communication device utilized in the wireless communication system for managing home cell selection.

2. Description of the Prior Art

A System Architecture Evolution (SAE) system, set forth by 3GPP (3rd Generation Partnership Project) is a new core network architecture for UMTS (Universal Mobile Telecommunications System), addressing cost-efficient deployment and operations for mass-market usage of IP services. The main network evolutions include meeting the targets for a radio-interface of a long term evolution (LTE) system, simplified network architecture, an AII-IP Network, only packet switched means for all services, no circuit switching, and support for mobility and service continuity between heterogeneous access networks, such as between 2G/3G, LTE, non-3GPP access systems.

The SAE core network includes an MME (Mobility Management Entity), an S-GW (Serving Gateway) and a P-GW (PDN gateway). The MME is a control plane entity that manages the attachment to the network, the authentication of the user equipment (UE), and interfaces an E-RAN (evolved radio access network) for the creation of relevant radio bearers.

Functions of the SAE include the Non-Access-Stratum (NAS) functions to be performed by the UE in idle mode, where the NAS signaling procedures between the UE and an evolved packet core network (EPC) are via an E-UTRAN (evolved UMTS radio access network) including eNBs (evolved Node-Bs), and layer 3 signaling procedures between the UE and the EPC are via non-3GPP access networks.

Under NAS functions, home cell deployments are defined as a single eNB used in a building or a small group of cells, e.g. in a campus deployment. Access to home cells is restricted to particular subscribers. In the home cell deployments, a CSG (closed subscriber group) cell as part of the PLMN (public land mobile network) is defined as a home cell and only suitable for a UE if an identity of the CSG cell is in a whitelist of the UE. That is, the whitelist stored in the UE is a list of CSG cells where the UE is allowed to camp, and the list of CSG cells is usually managed by the PLMN.

The current 3GPP specification does not specify clear actions for a UE, with at least one CSG entry in the whitelist, when it finds a suitable macro cell but finds no CSG cell. As a result, the UE can not select a CSG cell and thus the communication quality is possibly degraded.

As for service provision, service access fee in a CSG cell is less than that in a macro cell. The user may want to set the UE to select a CSG cell during cell selection. To benefit the user, the CSG cells shall have higher priority than the other normal cells, including macro cells, in a cell selection process.

When manual CSG cell selection is proposed, the UE can provide the manual function for the user to trigger CSG cell scanning and to select a CSG cell. The network may disable this function because the network wants the UE to follow the configuration result of a cell selection or a cell reselection. However, the current 3GPP specification does not provide an efficient way to control the activation of the manual CSG cell selection.

On the other hand, a user may perform the manual CSG cell selection abnormally. For example, in a manual CSG cell selection, the user may choose to access a CSG cell (e.g. a private eNB owned by another user) but the user is not allowed to access. According to the related current 3GPP specifications, a service request reject with a specific cause value is proposed if the UE is not allowed to access the CSG cell. However, the service request procedure is involved between the UE and the MME. The eNB has to establish connection to the MME, and then the MME has to check if the UE is valid for the CSG cell. This is not an efficient way because the radio and network resources are wasted in handling the erroneous access attempts.

### SUMMARY OF THE INVENTION

The present invention therefore provides a method and related communication device for managing home cell selection for a UE of a wireless communication system.

The present invention discloses a method of managing home cell selection for a UE of a wireless communication system including a whitelist capable of providing a list of accessible home cells. The method includes utilizing a flag for storing a preference for at least one of home cells and macro cells for cell selection.

The present invention further discloses a communication device of a wireless communication system for properly managing home cell selection. The communication device includes a processor, a communication interfacing unit, a control unit and a computer readable recording medium. The processor is used for processing storage data. The communication interfacing unit is used for exchanging signals with a peer communication device of the wireless communication system. The control unit is coupled to the processor and communication interfacing unit, and used for controlling the communication interfacing unit and the communication device according to processing results of the processor. The computer readable recording medium is coupled to the processor and used for storing the storage data. The storage data includes a whitelist capable of providing a list of accessible home cells, and a flag for storing a preference for at least one of home cells and macro cells for cell selection.

The present invention further discloses a method of managing home cell selection for a UE of a wireless communication system including a whitelist capable of providing a list of accessible home cells. The method includes utilizing a flag for controlling manual home cell selection.

The present invention further discloses a communication device of a wireless communication system for properly managing home cell selection. The communication device includes a processor, a communication interfacing unit, a control unit and a computer readable recording medium. The processor is used for processing storage data. The communication interfacing unit is used for exchanging signals with a peer communication device of the wireless communication system. The control unit is coupled to the processor and communication interfacing unit, and used for controlling the communication interfacing unit and the communication device according to processing results of the processor. The computer readable recording medium is coupled to the processor and used for storing the storage data. The storage data includes a whitelist capable of providing a list of accessible home cells, and a flag for controlling manual home cell selection.

The present invention further discloses a method of managing home cell selection for a UE of a wireless communication system including a whitelist capable of providing a list of accessible home cells. The method includes forbidding the manual home cell selection when a home cell that is not included in the whitelist is selected.

The present invention further discloses a communication device of a wireless communication system for properly managing home cell selection. The communication device includes a processor, a communication interfacing unit, a control unit and a computer readable recording medium. The processor is used for processing storage data. The communication interfacing unit is used for exchanging signals with a peer communication device of the wireless communication system. The control unit is coupled to the processor and communication interfacing unit, and used for controlling the communication interfacing unit and the communication device according to processing results of the processor. The computer readable recording medium is coupled to the processor and used for storing the storage data. The storage data includes a whitelist capable of providing a list of accessible home cells, and program code for forbidding the manual home cell selection when a home cell that is not included in the whitelist is selected during the manual home cell selection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system.

FIG. 2 is a schematic diagram of a communication device according to embodiments of the present invention.

FIG. 3 is a flowchart of a home cell selecting process according to an embodiment of the present invention.

FIG. 4 is a flowchart of a cell selecting managing process according to an embodiment of the present invention.

FIG. 5 is a flowchart of a cell selecting managing process according to an embodiment of the present invention.

### DETAILED DESCRIPTION

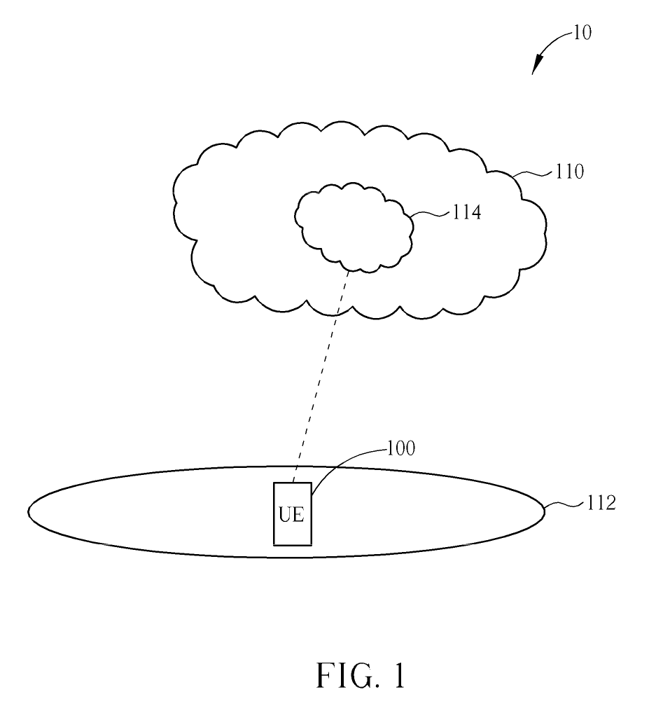

Please refer to FIG. 1, which is a schematic diagram of a wireless communication system 10. The wireless communication system 10 is established based on a System Architecture Evolution (SAE) system and includes a user equipment (UE) 100 and a Public Land Mobile Network (PLMN) 110. The components of the PLMN 110 are well known in the art and description thereof is omitted here. When the UE 100 camps on a macro cell 112 of a radio access network (RAN) 114 of the PLMN 110, the PLMN 110 can manage a whitelist of the UE 100 for providing accessible CSG (closed subscriber group) cells. The CSG cells are home cells that the UE 100 is allowed to access and provided by a home network. The UE 100 can search suitable CSG cells according to the whitelist for CSG services. The RAN can be a GSM/EDEG RAN (GERAN), a UMTS RAN (UTRAN), or an RAN of a long term evolution (LTE) system.

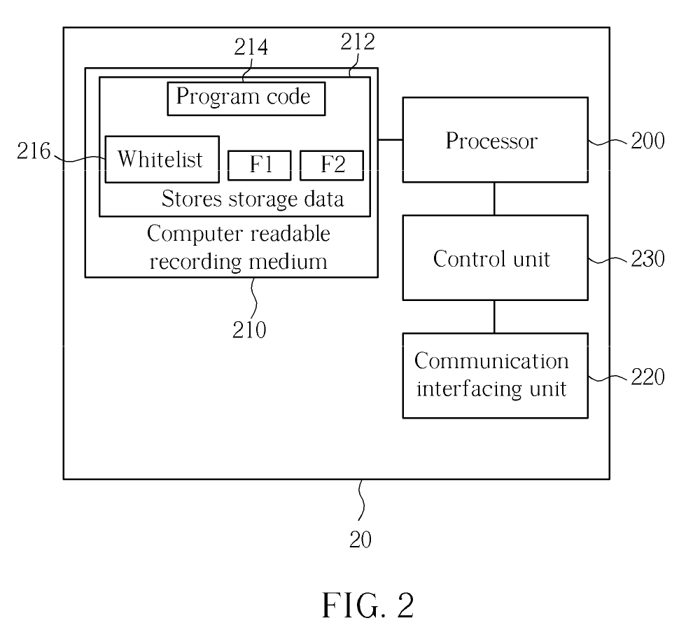

Please refer to FIG. 2, which illustrates a schematic diagram of a communication device 20 according to embodiments of the present invention. The communication device 20 can be the UE 100 shown in FIG. 1 and includes a processor 200, a computer readable recording medium 210, a communication interfacing unit 220 and a control unit 230. The computer readable recording medium 210 is any data storage device that stores storage data 212 thereafter read and processed by the processor 200. Examples of the computer readable recording medium 210 include a subscriber identity module (SIM), read-only memory (ROM), random-access memory (RAM), CD-ROMs, magnetic tapes, floppy disks, optical data storage devices, and carrier waves (such as data transmission through the Internet). The control unit 230 controls the communication interfacing unit 220 and related operations and states of the communication device 20 according to processing results of the process 200. The communication interfacing unit 220 is preferably a radio transceiver for wirelessly communicating with the e-Node Bs.

The storage data 212 includes program code 214, a whitelist 216, and flags F1 and F2. The whitelist 216 is capable of providing a list of accessible CSG cells. The number of CSG cells included in the whitelist 216 depends on configuration sent by the network. With the whitelist 216, the communication device 20 can search the listed CSG cells for CSG services when camping on a macro cell of the home network.

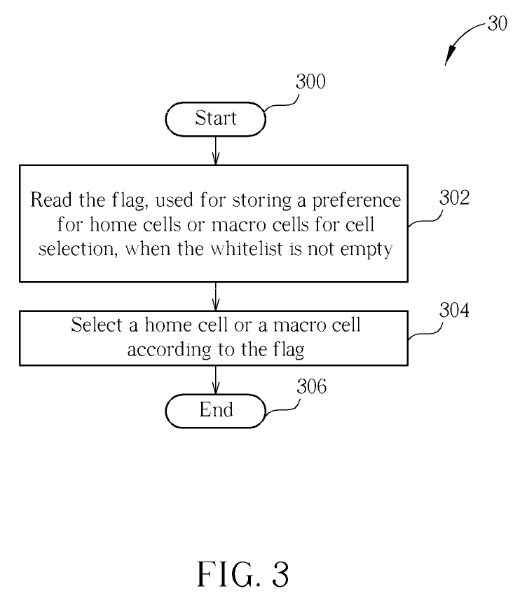

For cell selection, the flag F1 is used for storing a preference for CSG cells or macro cells for cell selection. In this situation, the embodiment of the present invention provides a home cell selecting process to allow the UE to select a home cell or a macro cell. Please refer to FIG. 3, which illustrates a flowchart of a home cell selecting process 30 according to an embodiment of the present invention. The home cell selecting process 30 is utilized for a UE including a whitelist to manage CSG cell selection and can be compiled into the program code 214. The home cell selecting process 30 includes the following steps:

Step 300: Start.

Step 302: Read the flag, used for storing a preference for home cells or macro cells for cell selection, when the whitelist is not empty.

Step 304: Select a home cell or a macro cell according to the flag.

Step 306: End.

According to the home cell selecting process 30, the UE reads the flag when the whitelist includes at least a CSG cell and then selects a CSG or macro cell according to the flag. Under compilation into the program code 214, the flag is the flag F1 stored in a SIM or stored in storage data 212, and the whitelist is the whitelist 216.

Please note that the preference herein can include information related to home cells, macro cells or combination of the home and macro cells. For example, the Flag can be set to one of four possible values: CSG only, CSG preferred, macro preferred and no preference. When the flag is set to CSG only, the UE can only select a CSG cell to camp on. When the flag is set to CSG preferred the UE tries to search a CSG cell in the whitelist to camp on during cell selection process. If the UE cannot find any CSG cell in the whitelist but find a macro cell, it selects the macro cell to camp on. When the flag is set to macro preferred, the UE tries to search a macro cell to camp on during cell selection process. If the UE cannot find any macro cell but find a CSG cell in the whitelist, it selects the CSG cell in the whitelist to camp on. When the flag is set to no preference, the UE selects either a CSG cell or a macro cell to camp on without preference during cell selection process.

Preferably, the flag is updated by the user or according to a dedicated signaling message sent by the network where the user equipment camps. The dedicated signaling message is a short message service (SMS) message.

When the embodiment of the present invention provides a manual CSG cell selection for the UE, a user can manually control the UE to trigger CSG cell scan and select any CSG cell in the scanned CSG cells. In this situation, the flag F2 is used for controlling manual CSG cell selection.

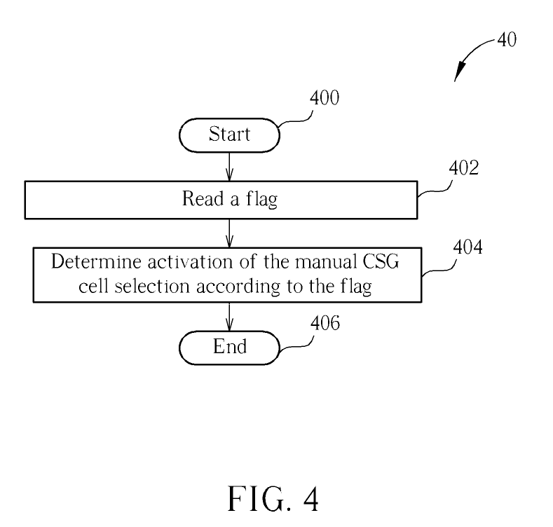

The embodiment of the present invention provides a cell selecting managing process to avoid system error due to inappropriate activation of the manual CSG cell selection. Please refer to FIG. 4, which illustrates a flowchart of a cell selecting managing process 40 according to an embodiment of the present invention. The cell selecting managing process 40 is utilized for a UE including a whitelist to manage CSG cell selection and can be compiled into the program code 214. The cell selecting managing process 40 includes the following steps:

Step 400: Start.

Step 402: Read a flag.

Step 404: Determine activation of the manual CSG cell selection according to the flag.

Step 406: End.

According to the cell selecting managing process 40, the UE reads the flag, when necessary (e.g. when powering on), and then determines whether the manual CSG cell selection is activated or not according to the flag.

Preferably, the flag is the flag F2 of the communication device 20 and stored in the SIM or stored in storage data 212. In addition, the flag is updated according to a dedicated signaling message sent by the network where the user equipment camps. The dedicated signaling message is an SMS message.

Through the cell selecting managing process 40, the network can control the UE to enable or disable the manual CSG cell selection by updating configuration of the flag.

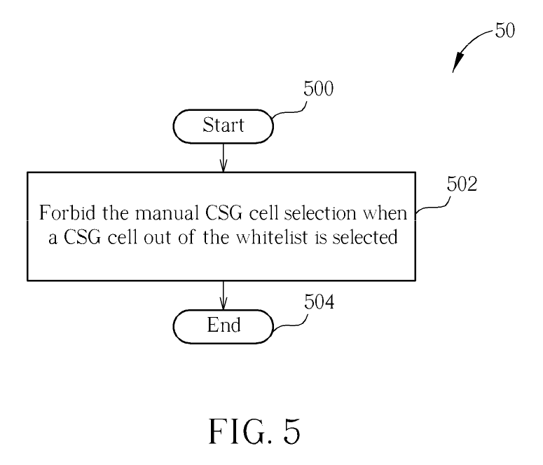

When the manual CSG selection is activated, the UE can scan CSG cells that do not exit in the whitelist. In this situation, the embodiment of the present invention provides a cell selecting managing process to benefit the network managing the manual CSG cell selection of the UE. Please refer to FIG. 5, which illustrates a flowchart of a cell selecting managing process 50 according to an embodiment of the present invention. The cell selecting managing process 50 is utilized for a UE including a whitelist to manage CSG cell selection and can be compiled into the program code 214. The cell selecting managing process 50 includes the following steps:

Step 500: Start.

Step 502: Forbid the manual CSG cell selection when a CSG cell out of the whitelist is selected.

Step 504: End.

According to the cell selecting managing process 50, the UE forbids continuing the manual CSG cell selection when a CSG cell out of the whitelist is selected. In other words, selecting any CSG cell that is not included in the whitelist triggers the UE to forbid the manual CSG cell selection.

In the prior art, the serving eNB of a CSG cell as part of the network needs to perform the complicated procedure with the MME (mobile management entity) for forbidding the CSG cell selection. With the cell selecting managing process 50, the embodiment of the present invention specifies the UE to actively forbid the manual CSG cell selection when the selected CSG cell is not valid as well as not in the whitelist. Thus, the procedure between the serving eNB of the CSG cell and furthermore the MME can be saved and abnormal CSG cell selection is avoided.

In conclusion, the embodiments of the present invention benefit the user in CSG cell services and improve control of the manual CSG cell selection.

Those skilled in the art will readily observe that numerous modifications and alterations of the device and method may be made while retaining the teachings of the invention.

What is claimed is:

1. A method of managing home cell selection for a user equipment of a wireless communication system, the user equipment comprising a whitelist capable of providing a list of accessible home cells, the method comprising:
utilizing a flag for storing a preference for at least one of home cells and macro cells for cell selection.

2. The method of claim 1 further comprising:
reading the flag when the whitelist is not empty; and
selecting a home cell or a macro cell according to the flag.

3. The method of claim 1, wherein the flag is updated according to a dedicated signaling message sent by a network of the wireless communication system where the user equipment camps.

4. The method of claim 3, wherein the dedicated signaling message is a short message service message.

5. A communication device of a wireless communication system for properly managing home cell selection, the communication device comprising:
a processor for processing storage data;
a communication interfacing unit for exchanging signals with a peer communication device of the wireless communication system;
a control unit coupled to the processor and communication interfacing unit, for controlling the communication interfacing unit and the communication device according to processing results of the processor; and
a computer readable recording medium coupled to the processor, for storing the storage data;
wherein the storage data comprises:
a whitelist capable of providing a list of accessible home cells; and
a flag for storing a preference for at least one of home cells and macro cells for cell selection.

6. The communication device of claim 5, wherein the storage data further comprises:
program code for reading the flag when the whitelist is not empty; and
program code for selecting a home cell or a macro cell according to the flag.

7. The communication device of claim 5, wherein the flag is updated according to a dedicated signaling message sent by a network of the wireless communication system where the user equipment camps.

8. The communication device of claim 7, wherein the dedicated signaling message is a short message service message.

9. A method of managing home cell selection for a user equipment of a wireless communication system, the user equipment comprising a whitelist capable of providing a list of accessible home cells, the method comprising:
utilizing a flag for controlling manual home cell selection.

10. The method of claim 9 further comprising determining activation of the manual home cell selection according to the flag.

11. The method of claim 9, wherein the flag is updated according to a dedicated signaling message sent by a network of the wireless communication system where the user equipment camps.

12. The method of claim 11, wherein the dedicated signaling message is a short message service message.

13. A communication device of a wireless communication system for properly managing home cell selection, the communication device comprising:
a processor for processing storage data;
a communication interfacing unit for exchanging signals with a peer communication device of the wireless communication system;
a control unit coupled to the processor and communication interfacing unit, for executing the communication interfacing unit and the communication device according to processing results of the processor; and
a computer readable recording medium coupled to the processor, for storing the storage data;
wherein the storage data comprises:
a whitelist capable of providing a list of accessible home cells; and
a flag for controlling manual home cell selection.

14. The communication device of claim 13, wherein the storage data further comprises program code for determining activation of the manual home cell selection according to the flag.

15. The communication device of claim 13, wherein the flag is updated according to a dedicated signaling message sent by a network of the wireless communication system where the user equipment camps.

16. The communication device of claim 15, wherein the dedicated signaling message is a short message service message.

17. A method of managing manual home cell selection for a user equipment of a wireless communication system, the user equipment comprising a whitelist capable of providing a list of accessible home cells, the method comprising:
forbidding the manual home cell selection when a home cell that is not included in the whitelist is selected during the manual home cell selection.

18. A communication device of a wireless communication system for properly managing manual home cell selection, the communication device comprising:
a processor for processing storage data;
a communication interfacing unit for exchanging signals with a peer communication device of the wireless communication system;
a control unit coupled to the processor and communication interfacing unit, for executing the communication interfacing unit and the communication device according to processing results of the processor; and
a computer readable recording medium coupled to the processor, for storing the storage data;
wherein the storage data comprises:
a whitelist capable of providing a list of accessible home cells and corresponding networks; and
program code for forbidding the manual home cell selection when a home cell that is not included in the whitelist is selected during the manual home cell selection.
